(19) United States
(12) Patent Application Publication
(10) Pub. No.: US 2022/0158888 A1
(43) Pub. Date: May 19, 2022

(54) METHOD TO REMOVE ABNORMAL CLIENTS IN A FEDERATED LEARNING MODEL

(71) Applicant: RESEARCH & BUSINESS FOUNDATION SUNGKYUNKWAN UNIVERSITY, Suwon-si (KR)

(72) Inventors: Jee Hyong LEE, Suwon-si (KR); Mann Soo HONG, Suwon-si (KR); Seok Kyu KANG, Suwon-si (KR)

(73) Assignee: RESEARCH & BUSINESS FOUNDATION SUNGKYUNKWAN UNIVERSITY, Suwon-si (KR)

(21) Appl. No.: 17/503,735

(22) Filed: Oct. 18, 2021

(30) Foreign Application Priority Data
Nov. 18, 2020 (KR) 10-2020-0154720

(51) Int. Cl. H04L 12/24; G06N 3/08

(52) U.S. Cl. CPC H04L 41/06; G06N 3/08

(57) ABSTRACT

Provided is a method of removing, by a server, an abnormal client in federated learning. A method of removing, by a server, an abnormal client in federated learning may include receiving, from a user equipment (UE), first weight values trained in a first local model, generating a first client model based on the first weight values, validating the first client model by using a validation data set in order to determine whether the first client model is legitimate, and removing the first weight values based on the first client model not being legitimate.

### CROSS REFERENCE TO RELATED APPLICATIONS

This application claims the benefit under 35 U.S.C. § 119(a) of Korean Patent Application No. 10-2020-0154720 filed on Nov. 18, 2020 in the Korean Intellectual Property Office, the entire disclosure of which is incorporated herein by reference for all purposes.

### BACKGROUND OF THE DISCLOSURE

### Field of the Disclosure

The present disclosure relates to a method of removing an abnormal client by detecting an out-of-distribution (OOD) local model based on a similarity between local models trained in respective clients and removing the OOD local model in a federated learning model.

### Related Art

Federated learning is a deep learning method developed for the purpose of protecting sensitive information including personal information. If federated learning is used, data does not need to be stored in a separate server or cloud because predicted data is managed in a terminal stage and each terminal can be trained in common using a common prediction model.

Accordingly, sensitive information related to a user can be protected because only information of a local model and a global model is exchanged between a server and a client and thus date collected by the client does not deviate from the management of the client.

However, federated learning has a possibility that out-of-distribution (OOD) data including noise or abnormal data may be learnt because information on all of data distributions is not present.

### SUMMARY

The present disclosure proposes a method of detecting and removing a model trained by OOD data in a federated learning environment.

Furthermore, the present disclosure proposes a federated learning framework to which a module for detecting and removing a model trained by OOD data has been applied in federated learning environment.

Technical objects to be achieved by the present disclosure are not limited to the aforementioned technical objects, and other technical objects not described above may be evidently understood by a person having ordinary knowledge in the art to which the present disclosure pertains from the following detailed description of the present disclosure.

In an aspect, a method of removing, by a server, an abnormal client in federated learning may include receiving, from a user equipment (UE), first weight values trained in a first local model, generating a first client model based on the first weight values, validating the first client model by using a validation data set in order to determine whether the first client model is legitimate, and removing the first weight values based on the first client model not being legitimate.

Furthermore, validating the first client model may include inputting the validation data set to the first client model, obtaining a first client vector from the first client model through a softmax function, determining a similarity between the first client vector and a second client vector related to another client model, and validating the first client model based on the similarity.

Furthermore, determining a similarity between the first client vector and a second client vector related to another client model may include obtaining the second client vector from the another client model through the softmax function, generating a center vector based on an average of the first client vector and the second client vector, and determining a similarity between the first client vector and the center vector.

Furthermore, the method may further include updating a global model of the server based on the first client model being legitimate.

Furthermore, the method may further include transmitting, to the UE, a weight value related to the updated global model in order to update the first local model.

Furthermore, the method may further include initializing a global model of the server and transmitting, to the UE, a structure of the global model and an initial weight value related to the initialized global model.

In another aspect, a server removing an abnormal client in federated learning may include a transceiver for transmitting and receiving signals, a memory, and an artificial intelligence (AI) processor for functionally controlling the transceiver and the memory. The AI processor may be configured to receive, from a user equipment (UE), first weight values trained in a first local model, generate a first client model based on the first weight values, validate the first client model by using a validation data set in order to determine whether the first client model is legitimate, and remove the first weight values based on the first client model not being legitimate.

### BRIEF DESCRIPTION OF THE DRAWINGS

FIG. 1 is a block diagram for describing an electronic device related to the present disclosure.

FIG. 2 is a block diagram of an AI device according to an embodiment of the present disclosure.

FIG. 3 is an example of a DNN model to which the present disclosure may be applied.

FIG. 4 is an example of a federated learning model to which the present disclosure may be applied.

FIG. 5 is an example of a framework to which the present disclosure may be applied.

FIG. 6 is an example of a process of generating a client vector to which the present disclosure may be applied.

FIG. 7 is an embodiment to which the present disclosure may be applied.

FIG. 8 is an embodiment of a server to which the present disclosure may be applied.

FIG. 9 is an example of a general apparatus to which the present disclosure may be applied.

The accompany drawings, which are included as part of the detailed description in order to help understanding of the present disclosure, provide embodiments of the present disclosure and describe the technical characteristics of the present disclosure along with the detailed description.

### DESCRIPTION OF EXEMPLARY EMBODIMENTS

Hereinafter, embodiments disclosed in the present disclosure are described in detail with reference to the accompanying drawings. The same or similar element is assigned the same reference numeral regardless of its reference numeral, and a redundant description thereof is omitted. It is to be noted that the suffixes of elements used in the following description, such as a “module” and a “unit”, are assigned or interchangeable with each other by taking into consideration only the ease of writing the present disclosure, but in themselves are not particularly given distinct meanings and roles. Furthermore, in describing an embodiment disclosed in the present disclosure, when it is determined that a detailed description of a related known technology may obscure the subject matter of an embodiment disclosed in the present disclosure, the detailed description will be omitted. Furthermore, it is to be understood that the accompanying drawings are merely intended to make easily understood the embodiments disclosed in the present disclosure, and the technical spirit disclosed in the present disclosure is not restricted by the accompanying drawings and includes all changes, equivalents, and substitutions which fall within the spirit and technical scope of the present disclosure.

Terms, such as a “first” and a “second”, may be used to describe various elements, but the elements are not restricted by the terms. The terms are used to only distinguish one element from the other element.

When it is described that one component is “connected” or “coupled” to the other component, it should be understood that one component may be directly connected or coupled to the other component, but a third component may exist between the two components. In contrast, in the present disclosure, when it is described that one component is “directly connected” or “directly coupled” to the other component, it should be understood that a third component does not exist between the two components.

An expression of the singular number may include an expression of the plural number unless clearly defined otherwise in the context.

In this application, it is to be understood that a term, such as “include” or “have”, is intended to designate that a characteristic, a number, a step, an operation, a component, a part or a combination of them described in the specification is present, and does not exclude the presence or addition possibility of one or more other characteristics, numbers, steps, operations, components, parts, or combinations of them in advance.

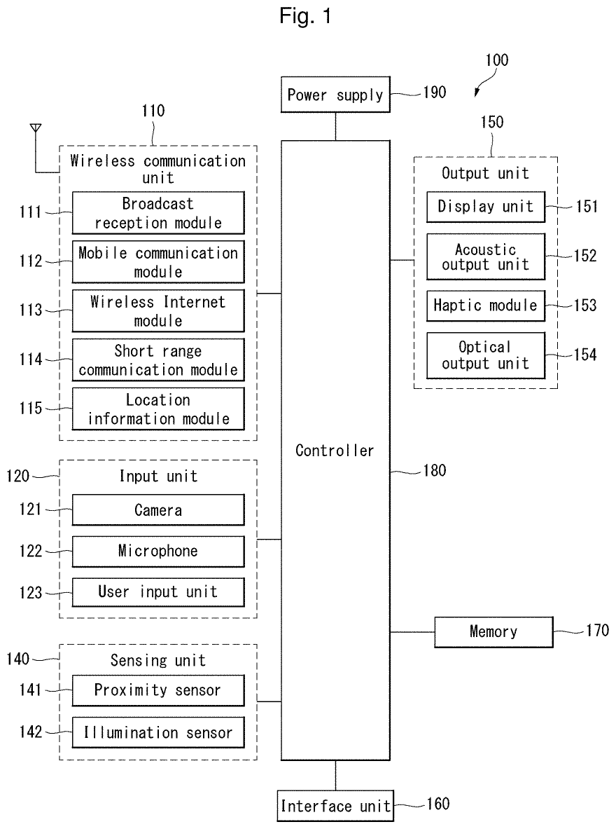

FIG. 1 is a block diagram for describing an electronic device related to the present disclosure.

Referring to FIG. 1, an electronic device 100 may include a wireless communication unit 110, an input unit 120, a sensing unit 140, an output unit 150, an interface unit 160, a memory 170, a controller 180, and a power supply 190. The elements illustrated in FIG. 1 are not essential to implement the electronic device. The electronic device described in the present disclosure may have elements larger or smaller than the aforementioned elements.

More specifically, among the elements, the wireless communication unit 110 may include one or more modules that enable wireless communication between the electronic device 100 and a wireless communication system, between the electronic device 100 and another electronic device 100, or between the electronic device 100 and an external server. Furthermore, the wireless communication unit 110 may include one or more modules that connect the electronic device 100 to one or more networks.

The wireless communication unit 110 may include at least one of a broadcast reception module 111, a mobile communication module 112, a wireless Internet module 113, a short range communication module 114, and a location information module 115.

The input unit 120 may include a camera 121 or image input unit for an image signal input, a microphone 122 or audio input unit for an audio signal input, or a user input unit 123 (e.g., a touch key or a mechanical key) for receiving information from a user. Voice data or image data collected by the input unit 120 may be analyzed and processed as a control command.

The sensing unit 140 may include one or more sensors for detecting at least one of information within the electronic device, surrounding environment information around the electronic device, and user information. For example, the sensing unit 140 may include at least one of a proximity sensor 141, an illumination sensor 142, a touch sensor, an acceleration sensor, a magnetic sensor, a G-sensor, a gyroscope sensor, a motion sensor, an RGB sensor, an infrared (IR) sensor, a finger scan sensor, an ultrasonic sensor, an optical sensor (e.g., the camera (refer to 121)), the microphone (refer to 122), a battery gauge, an environment sensor (e.g., a barometer, a hygrometer, a thermometer, a radioactivity detection sensor, a thermal detection sensor, or a gas detection sensor), a chemical sensor (e.g., an electronic nose, a healthcare sensor, or a bio recognition sensor). The electronic device disclosed in the present disclosure may combine and use pieces of information detected by at least two of such sensors.

The output unit 150 is for generating output related to a visual, auditory or tactile sense, and may include at least one of a display unit 151, an acoustic output unit 152, a haptic module 153, or an optical output unit 154. The display unit 151 may implement a touch screen by forming a mutual layer structure along with a touch sensor or being integrated with a touch sensor. The touch screen may function as the user input unit 123 that provides an input interface between the electronic device 100 and a user and may also provide an output interface between the electronic device 100 and a user.

The interface unit 160 functions as a passage with various types of external devices connected to the electronic device 100. The interface unit 160 may include at least one of a wired/wireless headset port, an external charger port, a wired/wireless data port, a memory card port, a port connected to a device including an identification module, an audio input/output (I/O) port, a video I/O port, or an earphone port. The electronic device 100 may perform proper control related to an external device connected thereto in response to a connection of an external device to the interface unit 160.

Furthermore, the memory 170 stores data supporting various functions of the electronic device 100. The memory 170 may store multiple application programs (or applications) driven in the electronic device 100, data for an operation of the electronic device 100, or instructions. At least some of such application programs may be downloaded from an external server through wireless communication. Furthermore at least some of such application programs may be present in the electronic device 100 from the time when the electronic device 100 was released for basic functions (e.g., incoming call and outgoing call functions and message reception and transmission functions) of the electronic device 100. The application program may be stored in the memory 170, may be installed in the electronic device 100, and may be driven to perform an operation (or function) of the electronic device by the controller 180.

In general, the controller 180 controls an overall operation of the electronic device 100 in addition to an operation related to an application program. The controller 180 may provide or process proper information or function for a user by processing a signal, data, or information inputted or outputted through the aforementioned elements or driving an application program stored in the memory 170.

Furthermore, the controller 180 may control at least some of the elements described with reference to FIG. 1 in order to drive an application program stored in the memory 170. Moreover, the controller 180 may combine and operate at least two of the elements included in the electronic device 100 in order to drive an application program.

The power supply 190 receives an external power source or an internal power source and supplies power to each of the elements included in the electronic device 100 under the control of the controller 180. The power supply 190 includes a battery. The battery may be an embedded battery or a replaceable type battery.

At least some of the elements may operate in cooperation with each other in order to implement an operation, control or a control method of the electronic device, which is described hereinafter according to various embodiments. Furthermore, an operation, control or a control method of the electronic device may be implemented in the electronic device by the driving of at least one application program stored in the memory 170.

Hereinafter, the aforementioned elements are more specifically described before various embodiments implemented by the electronic device 100 are described.

First, the wireless communication unit 110 is described. The broadcast reception module 111 of the wireless communication unit 110 receives a broadcast signal and/or broadcast-related information from an external broadcast management server through a broadcast channel. The broadcast channel may include a satellite channel or a terrestrial channel. Two or more broadcast reception modules may be provided to the electronic device 100 through simultaneous broadcast reception or broadcast channel switching for at least two broadcast channels.

The mobile communication module 112 transmits and receives wireless signals to and from at least one of a base station, an external user equipment (UE) or a server over a mobile communication network constructed according to technology standards or communication schemes (e.g., Global System for Mobile communication (GSM), Code Division Multi Access (CDMA), Code Division Multi Access 2000 (CDMA2000), Enhanced Voice-Data Optimized or Enhanced Voice-Data Only (EV-DO), Wideband CDMA (WCDMA), High Speed Downlink Packet Access (HSDPA), High Speed Uplink Packet Access HSUPA), Long Term Evolution LTE), Long Term Evolution-Advanced (LTE-A)) for mobile communication.

The wireless signal may include a voice call signal, a video telephony call signal or various types of data according to text/multimedia message transmission and reception.

The wireless Internet module 113 refers to a module for wireless Internet access, and may be embedded in or external to the electronic device 100. The wireless Internet module 113 is configured to transmit and receive wireless signals over a communication network according to wireless Internet technologies.

The wireless Internet technologies includes Wireless LAN (WLAN), Wireless-Fidelity (Wi-Fi), Wi-Fi Direct, Digital Living Network Alliance (DLNA), Wireless Broadband (WiBro), World Interoperability for Microwave Access (WiMAX), High Speed Downlink Packet Access (HSDPA), High Speed Uplink Packet Access (HSUPA), Long Term Evolution (LTE), and Long Term Evolution-Advanced (LTE-A), for example. The wireless Internet module 113 transmits and receives data according to at least one wireless Internet technology within a range including even an Internet technology not described above.

From a viewpoint that wireless Internet access based on WiBro, HSDPA, HSUPA, GSM, CDMA, WCDMA, LTE, or LTE-A is performed over a mobile communication network, the wireless Internet module 113 performing wireless Internet access over a mobile communication network may be understood a kind of the mobile communication module 112.

The short range communication module 114 is for short range communication, and may support short range communication by using at least one of technologies, such as Bluetooth, Radio Frequency Identification (RFID), Infrared Data Association (IrDA), Ultra Wideband (UWB), ZigBee, Near Field Communication (NFC), Wi-Fi, Wi-Fi Direct, Wireless Universal Serial Bus (Wireless USB), and Magnetic Secure Transmission (MST). The short range communication module 114 may support wireless communication between the electronic device 100 and a wireless communication system, between the electronic device 100 and another electronic device 100, or between the electronic device 100 and a network in which another electronic device 100 (or an external server) is placed over wireless area networks. The wireless area network may be a wireless personal area network.

In this case, another electronic device 100 may be a wearable device (e.g., a smartwatch, smart glasses, or a head mounted display (HMD)) which may exchange data (or may cooperate) with the electronic device 100 according to the present disclosure. The short range communication module 114 may detect (or recognize) a wearable device capable of communication with the electronic device 100 in the periphery of the electronic device 100. Moreover, if the detected wearable device is a device authenticated to communicating with the electronic device 100 according to the present disclosure, the controller 180 may transmit, to the wearable device, at least some of data processed by the electronic device 100 through the short range communication module 114. Accordingly, a user of the wearable device may use the data processed by the electronic device 100 through the wearable device. For example, the user may perform a call through the wearable device when the call is received by the electronic device 100 or may check a message through the wearable device when the message is received by the electronic device 100.

The location information module 115 is a module for obtaining a location (or current location) of the electronic device, and may include a Global Positioning System (GPS) module or a Wi-Fi module as a representative module. For example, the electronic device may obtain a location of the electronic device by using signals transmitted by GPS satellites if the GPS module is used. For another example, if a Wi-Fi module is used, the electronic device may obtain a location of the electronic device based on information of a wireless Access Point (AP) that transmits or receives a wireless signal to or from the Wi-Fi module. If necessary, the location information module 115 may perform any function of another module of the wireless communication unit 110 in order to obtain data relating to a location of the electronic device alternatively or additionally. The location information module 115 is a module used to obtain a location (or current location) of the electronic device, and is not limited to a module that directly calculates or obtain a location of the electronic device.

Next, the input unit 120 is to receive image information (or signal), an audio information (or signal), data, or information received from a user. For the reception of image information, the electronic device 100 may include one or a plurality of the cameras 121. The camera 121 processes an image frame of a still image or a moving image obtained by an image sensor in a video telephony mode or a photographing mode. The processed image frame may be displayed on the display unit 151 or may be stored in the memory 170. The plurality of cameras 121 included in the electronic device 100 may be arranged to form a matrix structure. A plurality of pieces of image information having various angles or focuses may be inputted to the electronic device 100 through the cameras 121 forming the matrix structure as described above. Furthermore, the plurality of cameras 121 may be arranged as a stereo structure in a way to obtain a left image and a right image for implementing a stereoscopic image.

The microphone 122 processes an external acoustic signal as electrical voice data. The processed voice data may be variously used depending on a function (or an application program being executed) being performed in the electronic device 100. Various noise cancellation algorithms for removing noise occurring in a process of receiving an external acoustic signal may be implemented in the microphone 122.

The user input unit 123 is for receiving information from a user. When information is received through the user input unit 123, the controller 180 may control an operation of the electronic device 100 so that the operation corresponds to the received information. The user input unit 123 may include mechanical input means (or a mechanical key) (e.g., a button disposed in the front, rear or side of the electronic device 100, a dome switch, a jog wheel, or a jog switch), and touch type input means. For example, the touch type input means may be formed of a virtual key, a soft key or a visual key displayed on a touch screen through software processing or may be formed of a touch key disposed in a portion other than the touch screen. The virtual key or the visual key has various forms and may be displayed on the touch screen, and may be formed of graphic, text, an icon, video or a combination of them, for example.

The sensing unit 140 detects at least one of information within the electronic device, information of a surrounding environment surrounding the electronic device, and user information, and generates a corresponding sensing signal. The controller 180 may control the driving or operation of the electronic device 100 based on such a sensing signal, or may perform data processing, a function or an operation related to an application program installed in the electronic device 100. Representative sensors among various sensors which may be included in the sensing unit 140 are more specifically described.

First, the proximity sensor 141 refers to a sensor for detecting an object that approaches a given detection surface or the presence or absence of a nearby object by using an electromagnetic field or infrared rays without a mechanical contact. The proximity sensor 141 may be disposed within an internal area of the electronic device surrounded by the touch screen or near the touch screen.

Examples of the proximity sensor 141 include a transmissive photoelectric sensor, a direct reflective photoelectric sensor, a mirror reflective photoelectric sensor, a high frequency oscillation type proximity sensor, a capacitive proximity sensor, a magnetic proximity sensor, and an infrared proximity sensor. If a touch screen is a capacitive type, the proximity sensor 141 may be configured to detect the proximity of an object based on a change in the magnetic field according to the proximity of the object having conductivity. In this case, the touch screen (or a touch sensor) itself may be classified as the proximity sensor.

For convenience of description, a behavior of an object recognized to be placed over a touch screen in close proximity with the touch screen while not coming into contact with the touch screen is named a “proximity touch.” A behavior of an object that actually comes into contact with a touch screen is named a “contact touch.” A location where an object is placed over a touch screen in close proximity with the touch screen means a location where the object is perpendicular to the touch screen when the object comes into contact with the touch screen in proximity with the touch screen. The proximity sensor 141 may detect a proximity touch or a proximity touch pattern (e.g., a proximity touch distance, a proximity touch direction, a proximity touch speed, a proximity touch time, a proximity touch location, or a proximity touch moving state). The controller 180 may process data (or information) corresponding to a proximity touch operation and a proximity touch pattern detected by the proximity sensor 141 as described above, and may display, on a touch screen, visual information corresponding to the processed data. Moreover, the controller 180 may control the electronic device 100 so that a different operation or data (or information) is processed depending on whether a touch on the same point on the touch screen is a proximity touch or a contact touch.

The touch sensor detects a touch (or a touch input) applied to a touch screen (or the display unit 151) by using at least one of several touch methods, such as a resistive method, capacitive method, an infrared method, an ultrasonic method, and a magnetic field method.

For example, the touch sensor may be configured to convert, into an electrical input signal, a change in pressure applied to a specific portion of the touch screen or capacitance generated in a specific portion of the touch screen. The touch sensor may be configured to detect a location or an area when a touch target that applies a touch on the touch screen touches the touch sensor, pressure upon touch, or capacitance upon touch. In this case, the touch target is an object that applies a touch to the touch sensor, and may be a finger, a touch pen, a stylus pen, or a pointer, for example.

As described above, when a touch input to the touch sensor is present, a corresponding signal(s) is transmitted to a touch controller. The touch controller processes the signal(s) and then transmits corresponding data to the controller 180. Accordingly, the controller 180 may identify which area of the display unit 151 has been touched. In this case, the touch controller may be an element separated from the controller 180 or may be the controller 180 itself.

The controller 180 may perform different control or the same control depending on the type of touch target that touches a touch screen (or a touch key provided other than the touch screen). Whether to perform different control or the same control depending on the type of touch target may be determined depending on a current operating state of the electronic device 100 or an application program that is now executed.

The touch sensor and the proximity sensor may detect various types of touches, such as a shot (or tap) touch, a long touch, a multi-touch, a drag touch, a flick touch, a pinch-in touch, a pinch-out touch), a swipe touch, and a hovering touch on the touch screen independently or in combination.

The ultrasonic sensor may recognize location information of a target to be detected by using ultrasonic waves. The controller 180 may calculate a location of a wave source based on information detected by an optical sensor and a plurality of ultrasonic sensors. The location of the wave source may be calculated using a property that light is very faster than ultrasonic waves, that is, the propensity that the time taken for light to reach the optical sensor is very faster than the time taken for ultrasonic waves to reach the ultrasonic sensor. More specifically, the location of the wave source may be calculated using a time lag with the time taken for light to reach ultrasonic waves as a reference signal.

The camera 121 described as an element of the input unit 120 includes at least one of a camera sensor (e.g., a CCD or a CMOS), a photo sensor (or an image sensor), and a laser sensor.

The camera 121 and the laser sensor may detect a touch on a target to be detected for a three-dimensional stereoscopic image in combination. The photo sensor may be stacked on a display device. The photo sensor is configured to scan a movement of a target to be detected, which is in close proximity to the touch screen. More specifically, the photo sensor has photo diodes and transistors (TR) mounted thereon in rows/columns thereof, and scans contents placed on the photo sensor by using an electrical signal changed in response to the amount of light applied to a photo diode. That is, the photo sensor calculates the coordinates of the target to be detected according to a change in the quantity of light, so that information on the location of the target to be detected can be obtained.

The display unit 151 displays (or outputs) information processed by the electronic device 100. For example, the display unit 151 may display information on an execution screen of an application program driven in the electronic device 100 or User Interface (UI) or Graphic User Interface (GUI) information according to such information of an execution screen.

Furthermore, the display unit 151 may be configured as a stereoscopic display unit that displays a stereoscopic image.

A three-dimensional display method, such as a stereoscopic method (glasses method), an auto stereoscopic method (glassless method), or a projection method (holographic method) may be applied to the stereoscopic display unit.

The acoustic output unit 152 may output audio data received from the wireless communication unit 110 in a call signal reception mode, a call mode, a recording mode, a voice recognition mode, or a broadcast reception mode or stored in the memory 170. The acoustic output unit 152 may output an acoustic signal related to a function (e.g., a call signal reception sound or a message reception sound) performed in the electronic device 100. The acoustic output unit 152 may include a receiver, a speaker, or a buzzer.

The haptic module 153 generates various tactile effects which may be felt by a user. A representative example of the tactile effect generated by the haptic module 153 may be vibration. The intensity and pattern of vibration generated by the haptic module 153 may be controlled by a user's selection or by the setting of the controller. For example, the haptic module 153 may synthesize and output or sequentially output different types of vibration.

In addition to vibration, the haptic module 153 may generate various tactile effects, such as effects based on the arrangement of pins moving perpendicular to a contact skin surface, a jet force or suction of the air through a nozzle or an inlet, the grazing of a skin surface, a contact of an electrode, and the stimulus of an electrostatic force, and effects based on the reappearance of cold and hot senses using an element capable of absorbing or discharging heat.

The haptic module 153 may be implemented to deliver a tactile effect through a direct contact and also to enable a user to feel a tactile effect through a muscle sense of a finger or arm. Two or more haptic modules 153 may be included depending on a configuration aspect of the electronic device 100.

The optical output unit 154 outputs a signal for providing notification of the occurrence of an event by using light of the light source of the electronic device 100. Examples of an event occurred in the electronic device 100 may include message reception, call signal reception, an unanswered call, an alarm, schedule notification, e-mail reception, and information reception through an application.

A signal outputted by the optical output unit 154 is implemented as the electronic device emits light having a single color or plural colors to the front or rear thereof. The output of the signal may be terminated as the electronic device detects that a user checks the event.

The interface unit 160 plays a role as a passage with all external devices connected to the electronic device 100. The interface unit 160 may receive data from an external device, may receive power and deliver power to each of the elements within the electronic device 100, or may transmit data within the electronic device 100 to an external device. For example, a wired/wireless headset port, an external charger port, a wired/wireless data port, a memory card port, a port connecting a device including an identification module, an audio I/O port, a video I/O port, or an earphone port may be included in the interface unit 160.

The identification module is a chip that stores a variety of types of information for authenticating a right to use the electronic device 100, and may include a user identify module (UIM), a subscriber identity module (SIM), and a universal subscriber identity module (USIM). A device (hereinafter an “ID device”) including the identification module may be fabricated in a smart card form. Accordingly, the ID device may be connected to the electronic device 100 through the interface unit 160.

Furthermore, when the electronic device 100 is connected to an external cradle, the interface unit 160 may be a passage along which power from a cradle is supplied to the electronic device 100 or a passage along which various command signals inputted to a cradle by a user are delivered to the electronic device 100. The various command signals and power received from the cradle may operate as a signal for recognizing that the electronic device 100 has been correctly mounted on the cradle.

The memory 170 may store a program for an operation of the controller 180, and may temporarily store inputted/outputted data (e.g., a phone book, a message, a still image, or a moving image). The memory 170 may store data about vibration and acoustic of various patterns outputted upon touch input on a touch screen.

The memory 170 may include at least one type of storage medium among a memory (e.g., an SD or XD memory), a random access memory (RAM), a static random access memory (SRAM), a read-only memory (ROM), an electrically erasable programmable read-only memory (EEPROM), a programmable read-only memory (PROM), a magnetic memory, a magnetic disk, and an optical disk having a flash memory type, a hard disk type, a Solid State Disk (SSD) type, a Silicon Disk Drive (SSD) type, a multimedia card micro type, or a card type. The electronic device 100 may operate in relation to a web storage that performs a storage function of the memory 170 on the Internet.

As described above, in general, the controller 180 controls an operation related to an application program and an overall operation of the electronic device 100. For example, when a state of the electronic device satisfies a set condition, the controller 180 may execute or release a locking state in which the input of a control command for applications by a user is limited.

Furthermore, the controller 180 may perform control and processing related to a voice call, data communication, or video telephony, or may perform pattern recognition processing for recognizing a handwriting input or a figure drawing input performed on a touch screen as text and an image. Moreover, the controller 180 may control any one of the aforementioned elements or may combine and control a plurality of the elements in order to implement various embodiments described hereinafter according to the present disclosure on the electronic device 100.

The power supply 190 receives an external power source or an internal power source and supplies power necessary for an operation of each of the elements under the control of the controller 180. The power supply 190 includes a battery. The battery may be an embedded battery that enables charging, and may be detachably coupled to a UE body for charging.

Furthermore, the power supply 190 may include a connection port. The connection port may be configured as an example of the interface unit 160 to which an external charger for supplying power is electrically connected for the charging of the battery.

For another example, the power supply 190 may be configured to charge the battery wirelessly without using the connection port. In this case, the power supply 190 may receive, from an external wireless power transmission device, power by using one or more of an inductive coupling method based on a magnetic induction phenomenon or a magnetic resonance coupling method based on an electromagnetic resonance phenomenon. In the present disclosure, the electronic device 100 may be collectively called a UE.

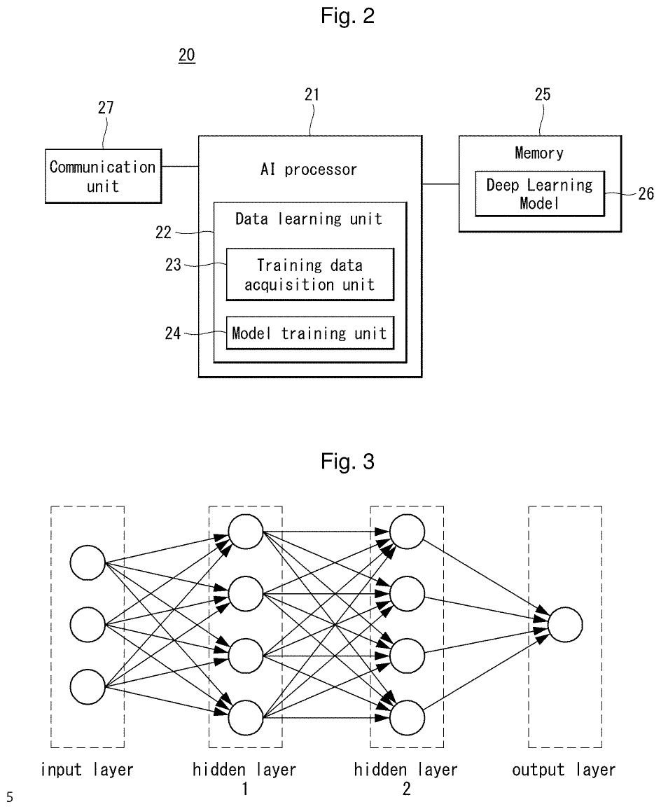

FIG. 2 is a block diagram of an AI device according to an embodiment of the present disclosure.

An AI device 20 may include an electronic device including an AI module capable of performing AI processing or a server including an AI module. Furthermore, the AI device 20 may be included as at least a part of the electronic device 100 illustrated in FIG. 1 to perform at least some of AI processing.

The AI device 20 may include an AI processor 21, a memory 25 and/or a communication unit 27.

The AI device 20 is a computing device capable of learning a neural network, and may be implemented as various electronic devices, such as a server, a desktop PC, a notebook PC, and a tablet PC.

The AI processor 21 may learn a neural network by using a program stored in the memory 25. In particular, the AI processor 21 may learn a neural network for recognizing vehicle-related data. In this case, the neural network for recognizing vehicle-related data may be designed to simulate a brain structure of a human being on a computer, and may include a plurality of network nodes having weights and simulating neurons of a neural network of a human being. The plurality of network modes may exchange data based on connection relations in a way to simulate synaptic activities of neurons that exchange signals through a synapse. In this case, the neural network may include a deep learning model developed from a neural network model. In the deep learning model, the plurality of network nodes is located in different layers, and may exchange data based on convolution connection relations. Examples of the neural network model includes various deep learning schemes, such as deep neural networks (DNN), convolutional deep neural networks (CNN), a recurrent Boltzmann machine (RNM), a restricted Boltzmann machine (BRM), a deep belief network (DBN), and a deep Q-network, and may be applied to fields, such as computer vision, voice cognition, natural language processing, and voice/signal processing.

The processor that performs the aforementioned function may be a general-purpose processor (e.g., a CPU), but may be an AI-dedicated processor (e.g., a GPU) for AI learning.

The memory 25 may store various programs and data necessary for an operation of the AI device 20. The memory 25 may be implemented using a non-volatile memory, a volatile memory, a flash memory, a hard disk drive (HDD) or a solid state drive (SDD). The memory 25 is accessed by the AI processor 21, and the reading/recording/modification/deletion/update of data may be performed on the AI processor 21. Furthermore, the memory 25 may store a neural network model (e.g., a deep learning model 26) generated through a learning algorithm for data classification/recognition according to an embodiment of the present disclosure.

The AI processor 21 may include a data learning unit 22 for learning a neural network for data classification/recognition. The data learning unit 22 may learn a reference about which training data will be used in order to determine data classification/recognition and how will data be classified and recognized using training data. The data learning unit 22 may obtain training data to be used for learning, and may train a deep learning model by applying the obtained training data to the deep learning model.

The data learning unit 22 may be fabricated in the form of at least one hardware chip and mounted on the AI device 20. For example, the data learning unit 22 may be fabricated in the form of a dedicated hardware chip for AI, and may be fabricated as a part of a general-purpose processor (e.g., a CPU) or a graphic-dedicated processor (e.g., a GPU) and mounted on the AI device 20. Furthermore, the data learning unit 22 may be implemented as a software module. If the data learning unit 22 is implemented as a software module (or a program module including instructions), the software module may be stored in non-transitory computer-readable media. In this case, at least one software module may be provided by an Operating System (OS) or may be provided by an application.

The data learning unit 22 may include a training data acquisition unit 23 and a model training unit 24.

The training data acquisition unit 23 may obtain training data necessary for a neural network model for classifying and recognizing data. For example, the training data acquisition unit 23 may obtain vehicle data and/or sample data to be inputted to a neural network model as training data.

The model training unit 24 may train a neural network model based on a determination criterion about how will given data be classified by using the obtained training data. In this case, the model training unit 24 may train a neural network model through supervised learning using at least some of training data as a determination criterion. Or the model training unit 24 may train a neural network model through unsupervised learning that discovers a determination criterion by autonomous learning using training data without supervision. Furthermore, the model training unit 24 may train a neural network model through reinforcement learning by using feedback about whether the results of a situation determination according to learning are correct. Furthermore, the model training unit 24 may train a neural network model by using a training algorithm including error back-propagation or a gradient decent.

When the neural network model is trained, the model training unit 24 may store the trained neural network model in the memory. The model training unit 24 may store the trained neural network model in a memory of a server connected to the AI device 20 over a wired or wireless network.

The data learning unit 22 may further include a training data pre-processor (not illustrated) and a training data selector (not illustrated) in order to improve the results of analysis of a recognition model or reduce a resource or time necessary to generate a recognition model.

The training data pre-processor may pre-process obtained data so that the obtained data is used for learning a situation determination. For example, the training data pre-processor may process the obtained data in a preset format so that the model training unit 24 can use training data obtained for learning for image recognition.

Furthermore, the training data selector may select data for learning among training data obtained by the training data acquisition unit 23 or training data pre-processed by the pre-processor. The selected training data may be provided to the model training unit 24. For example, the training data selector may select, as training data, only data of an object included in a specific area by detecting the specific area in an image obtained through a camera of a vehicle.

Furthermore, the data learning unit 22 may further include a model evaluator (not illustrated) in order to improve the results of analysis of the neural network model.

The model evaluator inputs evaluation data to the neural network model. If the results of analysis outputted from the evaluation data do not satisfy a given reference, the model evaluator may enable the model training unit 22 to be trained again. In this case, the evaluation data may be predefined data for evaluating a recognition model. For example, the model evaluator may evaluate that a recognition model has not satisfied a given criterion when the number or ratio of evaluation data whose results of analysis are not incorrect among results of analysis of the trained recognition model for the evaluation data exceeds a preset threshold.

The communication unit 27 may transmit the results of AI processing by the AI processor 21 to an external electronic device.

In this case, the external electronic device may be defined as a UE or a client. Furthermore, the AI device 20 may be implemented through a server or over a network.

The AI device 20 illustrated in FIG. 2 has been functionally divided and described as the AI processor 21 and the memory 25, and the communication unit 27, but the aforementioned elements may be integrated into one module and called an AI module.

Deep Neural Network (DNN) Model

FIG. 3 is an example of a DNN model to which the present disclosure may be applied.

The DNN is an artificial neural network (ANN) including several hidden layers between an input layer and an output layer. The DNN may model non-linear relationships like a common ANN.

For example, in a DNN structure for a thing identification model, each object may be represented as hierarchical architecture of image basic elements. In this case, additional layers may gather characteristics of lower layers gradually gathered. Such characteristics of the DNN enable the modeling of complex data with only a smaller number of units (nodes) than those of the ANN similarly performed.

As the number of hidden layers is increased, the ANN is said to be “deep”. A machine learning paradigm using, as a learning model, an ANN that has been sufficiently deepened is called deep learning. Furthermore, a sufficiently deep ANN used for such deep learning is collectively called a DNN.

In the present disclosure, data required to train a POI data generation model may be inputted to the input layer of a DNN. As the data experiences the hidden layers, meaningful data which may be used by a user may be generated through the output layer.

In the present disclosure, an ANN used for such a deep learning method is collectively called a DNN, but a deep learning method using a different method may be applied if it can output meaningful data using a similar method.

Federated Learning

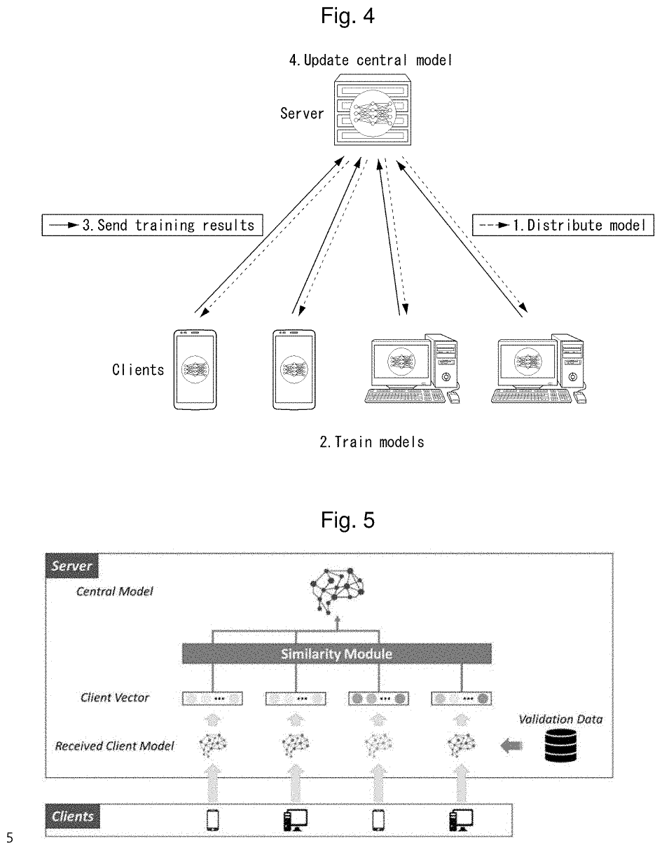

FIG. 4 is an example of a federated learning model to which the present disclosure may be applied.

In general, the training of the deep learning model requires a lot of data. In particular, to secure a data set having good quantity and quality while complying with a task is important for deep learning. With the development of the communication technology, data having good quality has been uploaded onto the Internet through mobile devices, but a task for securing data having good quality and satisfying a condition requires a lot of manpower, monetary, and time costs. Furthermore, there may be a problem with data which cannot be secured for a reason of data privacy or which is not open to other persons.

In a federated learning environment, data having a distribution greatly different from the existing data distribution may be added due to various causes, such as characteristics of a client, an environment in which data is collected, and a collection device error. However, in federated learning, there is no system for inspecting abnormal data in a server because the server cannot access training data used in a client. Since both the collection and use of data are performed in the client, the quantity and quality of data depend on only the client. However, it is impossible for the client to determine such out-of-distribution (OOD) data because the client cannot access data of all networks. Parameters of the client trained by OOD data may deteriorate the learning of all networks. Therefore, in order to secure learning improvement and model reliability, it is necessary to take measures by detecting an OOD client trained by OOD data in a learning process.

Referring to FIG. 4, federated learning is performed in a network including a server and multiple clients.

1. The server copies a model mounted thereon and distributes the model to the clients.

2. Each of the clients trains the distributed model by using owned data.

3. When the training is completed, each client transmits the training results to the server.

4. The server updates the mounted model by collecting the received results.

As the steps are repeatedly performed, federated learning may be performed. For example, in the present disclosure, the steps 1 to 4 may be denoted as one round.

In each round, the privacy of a user can be protected because the client does not leak owned data. Furthermore, since new samples can be consistently added, the client can easily secure data for training.

For example, the training results transmitted in the step 3 may be parameter values of a neural network.

Furthermore, a method of collecting the training results in the step 4 may be a method of updating the models with an average of the received parameter values.

For example, the parameter value may mean a weight.

The weight means a set of variables which may be trained by using a neural network of deep learning. Training data for each UE for improving a global model of the server may be generated in the form of a weight.

In such a federated learning environment, since data for training is owned by only a client, a server is unaware of information on such data.

This may cause the following problems.

First, it is impossible to construct a balanced data set. In deep learning, it is most proper that the number of data included in data sets having different propensities is similar because the model is trained toward data having a large number. However, environments in which clients collect data are different, and methods of collecting data are also different. For example, if a photo is used as data for an image classification task, some clients may photograph foxes, and some clients may photograph barleys. Furthermore, although clients photograph a fox identically, a client may photograph the fox at the front, a client may photograph the fox on the side, a client may photograph the entire body of the fox, and a client may photograph only the tail of the fox. Since the collection of such data is dependent on an environment and propensity of a client, the local model of each client may be trained based on the environment and propensity of a client. If the local model is biased in a specific direction, a process of completing the global model of the server may be long or may deteriorate its performance.

Second, the management of erroneous data is impossible. For example, there may be a case where a local model of a client is erroneously trained because the client has an error. More specifically, barley may be stored as a fox, or erroneous data may be collected for various causes, such as case where a camera for sensing is broken. A local model trained by such data is never helpful in the global model.

Third, there may be a case where erroneous data is intentionally inputted. This may be denoted as data poisoning. For example, data poisoning may mean that performance of a deep learning model is deteriorated by mixing data that hinders training. In a federated learning environment, a client has an absolute right to data. If the client intentionally attempts data poisoning, there is no method of avoiding, by a server, data poisoning.

That is, in the federated learning environment, the server cannot confirm or handle whether the local model of the client is correctly trained because the server cannot be aware of information of training data of a client.

However, as a method of solving the aforementioned problem, the reason why a method of correctly managing, by a client, data directly is not considered in the present disclosure is as follows.

First, since a client means a UE used by a common user, it is not assumed that such a common user is an expert of data or an expert of deep learning.

Second, although such a user is actually present, if a service to which federated learning has been applied is to be developed, several hundreds or thousands of users may be present. Accordingly, it is not appropriate to assume all of the users to be experts.

In the present disclosure, as described above, unnecessary or malicious data in a federated learning process is denoted as OOD data. A model trained by OOD data may be called an OOD model.

OOD as it is means that it has deviated from a (normal) distribution. This may hinder the training of a global model. That is, OOD is a target to be excluded from a federated learning process. In a federated learning environment, since a server cannot access data of a client, the server may use information of a model transmitted from a client to the server.

FIG. 5 is an example of a framework to which the present disclosure may be applied.

Referring to FIG. 5, a server may collect parameters of client models, and may update a global model by using the parameters, and may distribute the global model again. In the present disclosure, a server may extend the role of the server, may own a validation data set, and may detect an OOD client model by using the validation data set.

For example, when a client transmits parameters, a server may recover a client model again. Thereafter, the server may input its owned validation data set to the recovered client model. Thereafter, the server may calculate similarity by using results outputted by each client model, and may update the model of the server except parameters of N client models having the lowest similarity.

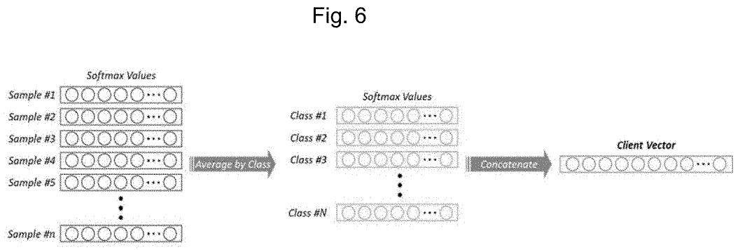

FIG. 6 is an example of a process of generating a client vector to which the present disclosure may be applied.

In the present disclosure, a validation data set may be defined as a set of data that follows a common data distribution of a target domain. Furthermore, the validation data set includes both input and label data.

When a server directly collects data for local model training, quality can be guaranteed by constructing a data set that is suitable for a purpose and that is balanced although the amount of data is not much. However, since the amount of data is not sufficient to train the local model by such a data set only, in the present disclosure, the server uses the data set as a validation data set. The validation data set is held in the server and executed only in the server. A trained specific model always outputs the same value when the same data is inputted. In the present disclosure, the validation data set may play a role of the “same data” by using such a characteristic.

For example, in federated learning, since a server distributes an updated model and applies the updated model to a client, all clients cannot start training with a model having the same initial value every round. Accordingly, it may be expected that distributions of parameters between client models trained by data having the same distribution will show similar propensities. Accordingly, if the same data is inputted to client models trained for the same purpose, output values of the client models may be similar.

Referring to FIG. 6, a server may calculate a first softmax vector, that is, an obtained vector value, by using a softmax function for each sample, may calculate a second softmax vector for each class, and may generate one vector by connecting the second softmax vectors. For example, a client vector may be a set of average softmax vectors for each class of each client model.

As described above, when the server inputs a validation data set to a reconstructed local model, softmax vectors may be outputted. The softmax vector is a representation of a possibility that one datum will be a class as a numerical value between 0 and 1. In the case of 10 classes, 10 numerical values are present. All numerical values are added to become 1. For example, if [0.1, 0.3, 0.6] is outputted when softmax vectors of three classes A, B, and C are outputted with respect to data X, X is C with the highest probability. If a corresponding model has been well trained, X will be C. If such a property is used, when softmax vectors are similar if X is inputted to another model, the two models may be said to be similar. A determination is made in a class unit because it cannot be determined by only one datum.

Each of softmax vectors obtained by inputting all validation data sets to one model may be the results of one datum. If an average of such vectors is calculated for each class, a softmax vector (a second softmax vector) may be obtained for each class. For example, in the case of 10 classes, one model may have 1010 tensors. The server may rearrange softmax vectors as 1001 tensors.

For example, in the present disclosure, such a tensor may be denoted as a client vector as a meaning that represents a client. The server performs such a process on all the local models.

More specifically, if the server performs the process on 10 models, 10 client vectors may be generated. Next, the server calculates an average of the 10 client vectors. The server may find similarity by calculating a distance between the average and each of the client vectors. As the distance from the average is more distant, this means that a corresponding client vector has lower similarity with other client vectors. Since each client vector is representative of the local model of a client, there is a good possibility that a local model including a client vector having low similarity will be an OOD model.

Similarity Module

A similarity module prevents that OOD data proceeds to a next step (i.e., a model update) by detecting a client model trained by OOD data based on the similarity between client vectors. For example, the similarity module may receive client vectors, may calculate an average of the client vectors, and may compare each of the client vectors and average similarity.

For example, referring to Equation 1 below, similarity may be determined using an Euclidian distance.

$$d ( p , q ) = \sqrt{{\sum }_{i = 1}^{n} {( {p}_{i} - {q}_{i} )}^{2}} \qquad [ Equation 1 ]$$

Referring to Equation 1, a similarity between p and q may be calculated through d(p,q).

For example, the server may designate N client models as OOD in order of lower similarity with an average. Thereafter, the server may exclude, from a model update, the N client models designated as OOD through the similarity module regardless of the actual number of OOD client models.

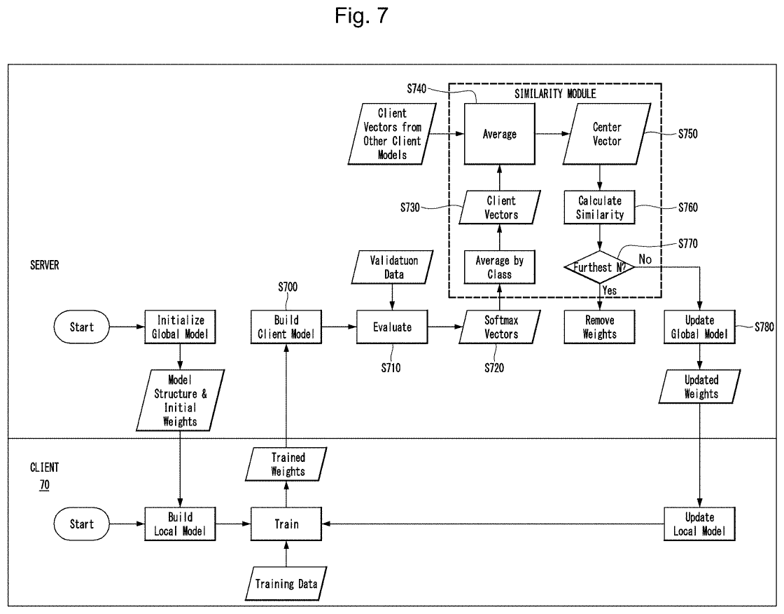

FIG. 7 is an embodiment to which the present disclosure may be applied.

Referring to FIG. 7, a federated learning environment in the present disclosure may include one or more clients (e.g., UEs) and a server that manages federated learning. Furthermore, the server may include the similarity module for removing an abnormal client.

The server initializes a global model for a global model distribution. The server transmits a model structure and an initial weight to one or more clients. A client 70 may build a local model having the same purpose as the global model by using the model structure and weight received from the server. The client 70 collects training data for training the local model in its use environment, and trains the local model. The client 70 may transmit the trained weight of the local model for federated learning to the server.

The server builds a client model by using the received trained weight (S700). The client model may be different for each client because each of the clients is built using the trained weight.

The server evaluates the client model by using a validation data set (S710). That is, the server generates a softmax vector related to the client model (S720). The server generates a first client vector by using an average of the softmax vectors for each class (S730).

The server calculates an average of client vectors based on the client vectors generated from other client models (S740), and calculates similarity with the first client vector (S760) by using, as an input value, a center vector indicative of the average (S750).

If it is determined that the local model of the client 70 is included in N client models designated as OOD based on the similarity with the first client vector related to the client 70 (S770), the server deletes the weight of the local model of the client 70. If it is determined that the local model of the client 70 is not OOD (S770), the server updates the global model by using a weight related to the local model of the client 70 (S780). The local model of the client 70 may be updated using a weight of the updated global model.

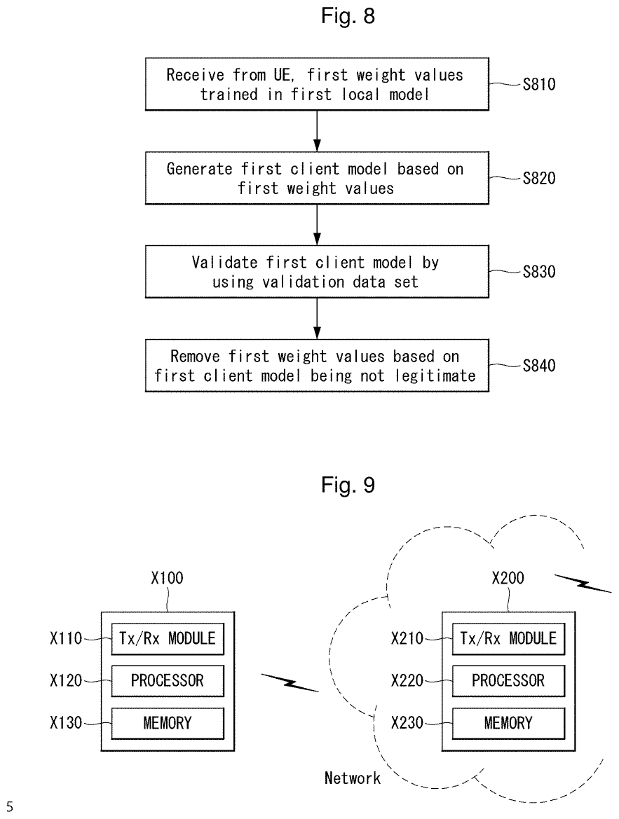

FIG. 8 is an embodiment of a server to which the present disclosure may be applied.

Referring to FIG. 8, the server is connected to a UE, may perform federated learning, and may remove an abnormal client.

The server receives, from a UE, first weight values trained in a first local model (S810). For example, the server may initialize a global model to be distributed, and may transmit, to the UE, a structure of the global model and an initial weight value related to the initialized global model. The UE may build a first local model based on received data. The UE may train the first local model in its use environment.

The server generates a first client model based on the first weight values (S820).

The server validates the first client model by using a validation data set in order to determine whether the first client model is legitimate (S830). For example, the server inputs the validation data set to the first client model, and may obtain a first client vector from the first client model through a softmax function. A similarity module included in the server may determine a similarity between the first client vector and a second client vector related to another client model through a Euclidean function. The server may validate the first client model based on the similarity.

More specifically, in order to determine the similarity between the first client vector and a second client vector related to the another client model, the server may obtain the second client vector from the another client model through a softmax function, may generate a center vector based on an average of the first client vector and the second client vector, and may determine a similarity between the first client vector and the center vector.

The server removes the first weight values based on the first client model being not legitimate (S840). Accordingly, in updating the global model, an illegitimate first client model can be excluded.

If the first client model is legitimate, the server may update the global model by using the first client model. Thereafter, in order to update the first local model, the server may transmit, to the UE, a weight value related to the updated global model.

General Device to which the Present Disclosure May be Applied

Referring to FIG. 9, a server X200 according to a proposed embodiment may include a communication module X210, a processor X220, and a memory X230. The communication module X210 is also referred to as a radio frequency (RF) unit. The communication module X210 may be configured to transmit a variety of types of signals, data, and information to an external device and to receive a variety of types of signals, data, and information from the external device. The server X200 may be connected to the external device in a wired and/or wireless way. The communication module X210 may be implemented to be separated into a transmitter and a receiver. The processor X220 may control an overall operation of the server X200, and may be configured to perform a function for calculating and processing information that will be transmitted to and received from the external device by the server X200. Furthermore, the processor X220 may be configured to perform a server operation proposed in the present disclosure. The processor X220 may control the communication module X210 to transmit data or a message to a UE, another vehicle or another server according to the proposal of the present disclosure. The memory X230 may store the calculated and processed information for a given time, and may be substituted with an element, such as a buffer.

Furthermore, detailed configurations of the UE X100 and the server X200 may be implemented so that the contents described in various embodiments of the present disclosure are independently applied to the detailed configurations or two or more of the various embodiments of the present disclosure are simultaneously applied to the detailed configurations. A description of redundant contents is omitted for clarity.

The aforementioned present disclosure may be implemented in a medium on which a program has been recorded as a computer-readable code. The computer-readable medium includes all types of recording devices in which data readable by a computer system is stored. Examples of the computer-readable medium may include a Hard Disk Drive (HDD), a Solid State Disk (SDD), a Silicon Disk Drive (SDD), a ROM, a RAM, a CD-ROM, a magnetic tape, a floppy disk, an optical data storage device, and also includes carrier waves (e.g., transmission through the Internet). Accordingly, the detailed description should not be construed as being limitative, but should be considered to be illustrative from all aspects. The scope of the present disclosure should be determined by reasonable analysis of the attached claims, and all changes within the equivalent scope of the present disclosure are included in the scope of the present disclosure.

According to an embodiment of the present disclosure, in a federated learning environment, performance of a global model can be improved by detecting and removing a model trained by OOD data.

Furthermore, according to an embodiment of the present disclosure, in a federated learning environment, a federated learning framework to which a module for detecting and removing a model trained by OOD data has been applied can be developed.

Effects which may be obtained the present disclosure are not limited to the aforementioned effects, and other technical effects not described above may be evidently understood by a person having ordinary knowledge in the art to which the present disclosure pertains from the following description.

Furthermore, although the services and embodiments have been chiefly described, they are only illustrative and are not intended to limit the present disclosure. A person having ordinary knowledge in the art to which the present disclosure pertains may understand that various modifications and applications not illustrated above are possible without departing from the essential characteristics of the present services and embodiments. For example, each of the elements described in the embodiments may be modified and implemented. Furthermore, differences related to such modifications and applications should be construed as belonging to the scope of the present disclosure defined in the appended claims.

What is claimed is:

1. A method of removing, by a server, an abnormal client in federated learning, comprising:
receiving, from a user equipment (UE), first weight values trained in a first local model;
generating a first client model based on the first weight values;
validating the first client model by using a validation data set in order to determine whether the first client model is legitimate; and
removing the first weight values based on the first client model not being legitimate.

2. The method of claim 1, wherein validating the first client model comprises:
inputting the validation data set to the first client model;
obtaining a first client vector from the first client model through a softmax function;
determining a similarity between the first client vector and a second client vector related to another client model; and
validating the first client model based on the similarity.

3. The method of claim 2,
wherein determining a similarity between the first client vector and a second client vector related to another client model comprises:
obtaining the second client vector from the another client model through the softmax function;
generating a center vector based on an average of the first client vector and the second client vector; and
determining a similarity between the first client vector and the center vector.

4. The method of claim 2, further comprising updating a global model of the server based on the first client model being legitimate.

5. The method of claim 4, further comprising transmitting, to the UE, a weight value related to the updated global model in order to update the first local model.

6. The method of claim 1, further comprising:
initializing a global model of the server; and
transmitting, to the UE, a structure of the global model and an initial weight value related to the initialized global model.

7. A server removing an abnormal client in federated learning, comprising:
a transceiver for transmitting and receiving signals;
a memory; and
an artificial intelligence (AI) processor for functionally controlling the transceiver and the memory,
wherein the AI processor is configured to:
receive, from a user equipment (UE), first weight values trained in a first local model,
generate a first client model based on the first weight values,
validate the first client model by using a validation data set in order to determine whether the first client model is legitimate, and
remove the first weight values based on the first client model not being legitimate.

8. The server of claim 7,
wherein the AI processor is configured to:
in order to validate the first client model,
input the validation data set to the first client model,
obtain a first client vector from the first client model through a softmax function,
determine a similarity between the first client vector and a second client vector related to another client model, and
validate the first client model based on the similarity.

9. The server of claim 8,
wherein the AI processor is configured to:
in order to determine the similarity between the first client vector and the second client vector related to the another client model,
obtain the second client vector from the another client model through the softmax function,
generate a center vector based on an average of the first client vector and the second client vector, and
determine a similarity between the first client vector and the center vector.

10. The server of claim 8,
wherein the AI processor is configured to update a global model of the server based on the first client model being legitimate.

11. The server of claim 10,
wherein the AI processor is configured to transmit, to the UE, a weight value related to the updated global model in order to update the first local model.

12. The server of claim 7,
wherein the AI processor is configured to:
initialize a global model of the server, and
transmit, to the UE, a structure of the global model and an initial weight value related to the initialized global model.
